(19) United States
(12) Patent Application Publication
(10) Pub. No.: US 2006/0180104 A1
(43) Pub. Date: Aug. 17, 2006

(54) Internal combustion engine with actuating oscillating cylinders

(76) Inventor: Joseph E. Springer, Montclair, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/056,519

(22) Filed: Feb. 11, 2005

(51) Int. Cl. F02B 33/22; F02B 41/06; F02B 59/00

(52) U.S. Cl. 123/70 R; 123/42

(57) ABSTRACT

An internal combustion engine having one or more modules each employing fluidly-communicating, oscillating, power cylinder and air cylinder. The power and air cylinders oscillate about separate, individually supporting sets of trunnions positioned non-linearly with respect to each other and permitting the passage of air therethrough. The air cylinder includes a pre-combustion chamber for the purpose of withholding the delivery of a portion of compressed air to the power cylinder until all spent gases have been evacuated from the power cylinder. Means for enhancing fuel dispersion and/or vaporization is provided whereby cavities are provided in the cap of both the air cylinder and the power cylinder that are in selective synchronous fluid communication. A blower is provided to not only assist in the elimination of exhaust from the combustion chamber but also purge the combustion piston cap cavity of exhaust backflow prior to the delivery of fresh charge

### BACKGROUND OF THE INVENTION

1. Field of the Invention

The present invention relates to internal combustion engines having one or more modules that employ pairs of fluidly communicating oscillating cylinders and, more particularly, to an oscillating cylinder engine that enhances fuel burning efficiency.

2. Description of the Related Art

With conventional internal combustion engines, power is derived from the combustion of air and fuel (e.g., gasoline and air) resulting from the ignition of a highly compressed air-fuel mixture contained within one or more combustion chambers. In a typical internal combustion engine, the inward motion of a reciprocating piston within a cylinder compresses the air-fuel mixture for ignition and combustion. The expanding gases resulting from combustion impart a tremendous force against the piston and drive it outwardly within the cylinder. The piston is typically linked to a crankshaft in a manner such that linear reciprocating motion of the piston is converted into rotational motion of a drive shaft.

A typical sequence of operation of a combustion engine includes delivery of the air and fuel into the combustion cylinder, compression of the air-fuel mixture within the cylinder by the piston, combustion of the mixture which powers the piston and crankshaft, and then exhaust of the “spent” fuel mixture from the cylinder. Repeated performance of these steps results in the continuous delivery of power to the crankshaft which, in turn, can be used to do the desired work, such as propel a motorized vehicle.

Internal combustion engines employing reciprocating pistons may be categorized as “two-stroke” or “four-stroke” engines. The two-stroke cycle engine completes the four steps of the power producing cycle; i.e., fuel intake, compression, power, and exhaust of the spent fuel mixture, during a single reciprocation of the piston (and one resulting revolution of the crankshaft). In contrast, a four-stroke engine requires two revolutions of the crankshaft for a power producing cycle and, thus, two upward and downward strokes of the piston to complete the intake, compression, power, and exhaust steps.

Two-stroke engines typically pre-mix the air and fuel before delivery into the cylinder. The air-fuel mixture is then delivered and the spent combustion gases are exhausted from the cylinder when the reciprocating piston exposes intake and exhaust ports, respectively, in the cylinder walls. Often the piston exposes both the intake and exhaust ports simultaneously, allowing the fresh fuel mixture to purge the cylinder of the exhaust gases. In contrast, the four-stroke engine typically delivers the fuel only after the spent gases have been exhausted and the fuel is frequently delivered into the cylinder separately from the incoming air. Control of the incoming air and exhaust of the spent gases in most four-stroke engines is achieved with an array of mechanically linked intake and exhaust valves.

Two-stroke engines offer certain advantages over four-stroke engines because the former produces power strokes twice as often as compared to the four-stroke engine. This permits two-stroke engines to be smaller in size and lighter in weight than four-stroke engines with a comparable power output. Two-stroke engines are also less expensive to manufacture and build because they require fewer parts that are subject to wear, breakdown and replacement. Two-stroke engines also dispense with the need for a complicated intake and exhaust valve structure.

Two-stroke engines, however, are generally not as efficient as four-stroke engines because two-stroke engines do not effectively remove all of the exhaust gases from the combustion chamber before the next power producing cycle. In a typical two-stroke engine, both the intake port and the exhaust port are open at the same time to enable the new air-fuel mixture to flow into the combustion chamber and to allow the escape of the exhaust gases. The concurrent opening of the intake and exhaust ports allows the fresh air-fuel mixture to purge the exhaust gases out of the combustion chamber through the exhaust port. This is disadvantageous because some of the fresh air-fuel mixture escapes through the exhaust port reducing engine efficiency by failing to utilize all of the fresh air-fuel mixture during the combination process. In addition, some of the exhaust gases mix with the incoming fresh air-fuel mixture which further reduces engine efficiency because noncombustible gases remain in the combustion chamber during the subsequent power cycle.

Efforts to improve the removal of the exhaust gases from the combustion chamber have focused primarily on the development of improved scavenging or removal of the exhaust gases by positively pumping the fresh air-fuel mixture into the combustion chamber. As known in the art, one method uses the changing volume of the crankcase (which changes with the reciprocating movement of the piston) to pressurize the incoming air to help force the exhaust gases out of the cylinder. This approach leads to considerable complexity in crankcase design, requires additional working components, creates sealing and lubrication problems, and adds to the cost of manufacturing, operation and maintenance.

Another known method to improve removal of the exhaust gases from the combustion chamber is to use devices such as a supercharger to force the air-fuel mixture into the cylinder. This subject is discussed at length in the September 1992 issue of Popular Mechanics at page 33. Superchargers comprise a pump that increases the pressure of the air-fuel mixture entering the cylinder. Superchargers generally include a blower that is driven by a belt, gear or chain that is connected to the drive shaft of the engine. However, superchargers include serious disadvantages such as increased weight, added complexity, reliability handicaps, and maintenance problems.

Conventional internal combustion engines also lose power and efficiency because the reciprocating piston is attached to the crankshaft by a connecting rod and a wrist pin to translate linear reciprocating motion of the piston into rotational movement of the crankshaft. The use of the connecting rod and wrist pin results in uneven and excessive wear to the piston and cylinder wall because lateral forces are transmitted through the connecting rod in directions other than through the centerline of the piston. In a typical engine, the cylinders are held stationary in the engine block and the pistons are connected to the rotating crankshaft by the connecting rod which pivots about the wrist pin. When the piston is in any position other than the top dead center or bottom dead center of the cylinder, the force acting through the centerline of the piston is not aligned with the axis of rotation of the crankshaft. Transverse or lateral force vectors, which cause uneven wear of the piston, are created because the force is not acting directly upon the crankshaft.

This disadvantage is overcome by using oscillating cylinders that rotate about a set of trunnions so that the centerline of the piston is at all times aligned with the crank throw of the crankshaft to eliminate the lateral force vectors. The oscillating cylinder engine uses a piston rod that directly connects the piston to the crankshaft to eliminate the need for the wrist pin and connecting rod. The trunnions enable the cylinders to oscillate back and forth across a small arc while tracking the rotational movement of the point of contact between the base of the piston rod and the crankshaft. The rigid, fixed-length piston rod connecting the piston to the crankshaft causes the cylinder to oscillate while the piston rotates semi-elliptical in their motion to turn the crankshaft.

Oscillating cylinder engines of old required a complicated maze of passageways and connections to direct the air-fuel mixture and exhaust gases through the engine. For example, U.S. Pat. No. 878,578 issued to Thompson discloses an engine with two oscillating cylinders. The cylinders are connected by four different passageways to control the flow of the air-fuel mixture into each cylinder and the removal of the exhaust gases from each cylinder. These passageways create a complicated system that is difficult to manufacture and expensive to assemble U.S. Pat. No. 1,135,365 issued to Dock and U.S. Pat. No. 1,877,760 issued to Berner disclose oscillating cylinder internal combustion engines where the rocking motion created by the oscillating cylinder requires a complex series of chambers, passageways and apertures to regulate the flow of the fuel mixture and exhaust gases through the engine. Thus, prior oscillating cylinder engines required a plurality of passageways and interconnects to control the flow of the air-fuel mixture and exhaust of the spent gases from the combustion chamber.

As shown in my earlier U.S. Pat. No. 5,275,134, I disclosed an internal combustion engine with adjacent air and power cylinders that oscillate about two sets of adjoining co-axial trunnions. The trunnions eliminate the complicated tubing and passageways required to control the flow of the incoming air-fuel mixture and exhaust of the spent gases through the engine because the hollow trunnions periodically align openings or apertures in the air and power cylinder walls to control the flow of the gases through the engine.

It will be readily appreciated that an oscillating cylinder engine that provides complete scavenging or removal of the exhaust gases from the combustion chamber is very advantageous. The engine should allow complete mixing of the air and fuel without the loss of any unburned fuel through the exhaust port. The engine should also be simple, easy to manufacture, lightweight, compact, and require fewer parts than a comparable reciprocating piston engine.

### SUMMARY OF THE INVENTION

The present invention is an improved two-stroke, internal combustion engine that employs adjacent oscillating air and power cylinders. One advantageous feature of the present invention is an improved air/fuel mixture delivery assembly that enhances vaporization and dispersion of the fuel within the mixture prior to combustion. In one embodiment, the present invention comprises an arrangement of a cavity within a pumper piston cap to permit the transmission of fuel and air mixture through the cap in a manner to permit timed injection into the combustion chamber. In the preferred embodiment, the cap includes a manifold cavity that directs the mixture through the cap and into a storage cavity in the wrist pin of the pumper piston, with a connecting tube in the piston itself. The air and fuel mixture is stored within the storage cavity momentarily each cycle until the pumper piston aligns with a charge aperture in the wall separating the pumper chamber from the combustion chamber.

Advantageously, the manifold cavity comprises a plurality of inlets on the top of the pumper piston cap that from the pumper chamber through to the storage cavity. Each inlet leads to a slot between the inlet and manifold cavity. With each slot a check valve is provided that permits the selective cyclical transfer of charge into the storage cavity until delivered into the combustion chamber. In one embodiment, the check valve is a spring-supported ball free to move within a slot depending upon the direction of pressure against the ball. The inlet is configured so that the spring biased ball seats tightly in a sealed manner to prevent the backflow of charge back into the pumper chamber after the charge has been introduced into the manifold cavity.

Another advantageous feature of the present invention is that the combustion piston is topped with a cap that is preferably domed in such a configuration to enhance a swirl of charge flow. By introducing the air and fuel into the combustion chamber just above the combustion piston cap, a swirl of the introduced fluid will result, enhancing the even distribution of the air and fuel and increasing the burn efficiency. The combustion piston cap comprises a delivery cavity through which the charge is delivered to the combustion chamber. The delivery cavity has an entry port into which charge enters from the pumper chamber and an exit port through which the charge enters the combustion chamber. During the combustion cycle, it is possible that combustion exhaust may enter the delivery cavity. The present invention is configured so that the entry port of the delivery cavity aligns with the blower outlet once each cycle to blow out any residual exhaust in the delivery cavity. One advantage of the present invention is that it provides an effective vehicle for vaporizing the fuel, enhancing the mixture of fuel and air, prior to injection into the combustion chamber. By doing so, it may be possible to decrease the amount of fuel delivered to obtain the same power.

In the present embodiment, the pumper piston and the combustion piston are positioned with respect to the crank shaft so as to move synchronously in cycle so that both pistons reach apex simultaneously. It is contemplated that a variation in the configuration of the present invention would permit asynchronous movement within respective cylinders and still work effectively.

It is contemplated that an optional feature may be provided to facilitate reciprocation of the piston in the combustion and pumper chamber. Specifically, in one embodiment, at least one roller is provided on each side of the piston rod that rides axially within the chamber in a groove in the side wall of the chamber. If desired, more than one roller on each side may be provided.

One advantageous feature of the present invention is a blower configured and positioned to purge the combustion chamber of exhaust, permitting a faster exchange of exhaust and refreshed charge. The blower is preferably powered by the crank shaft. Preferably, the blower is also powered during start up by an auxiliary motor that drives the blower initially to enhance its effectiveness in forcing exhaust out of the combustion chamber. Preferably, means for providing a misted supply of water to the blower line that draws heat from the engine will serve to crack some of the water to generate hydrogen from the water molecules. The hydrogen is then delivered as part of the blower supply to the combustion chamber to enhance combustion.

An optional feature of the present invention comprises a breakdown crank that facilitates the removal of the pumper chamber from the engine if so desired for replacement or repair. The breakdown crank comprises a segmented shaft having a first portion linked to the combustion piston rod and a second portion linked to the pumper piston rod. The first portion has a first end that abuts a first end of the second portion, each of which comprises an internal bore portion that join together to form a contiguous bore. A pin resides within the bore for purposes of aligning the first and second portions of the crank. At least one key is radially positioned within a keyway at the juncture of the first and second shaft portions to secure the pin within the bore and to ensure radial alignment. With this arrangement, if it is desired to detach the pumper side of the engine from the combustion side, the key or keys can be removed and the crank shaft portions detached.

The present invention further comprises a variable compression feature that permits a change in the volume of the combustion chamber that impacts the resulting power generated by combustion. In the preferred embodiment, the trunnion about which the combustion chamber oscillates sits within an eccentric ring that itself sits within an aperture in the wall. The eccentric ring is configured to rotate in a manner so that the axial position of the trunnion relative to the combustion wall moves so as to change the combustion chamber volume. Preferably, the trunnion moves relative to the chamber 62/1000 inches. If desired, the eccentric ring may be secured within an axial slot so that as the ring rotates, lateral movement does not occur.

### BRIEF DESCRIPTION OF THE DRAWINGS

FIG. 1 is a side view of the first preferred embodiment of the present invention showing two mechanically linked side-by-side power cycle modules in virtual mirror image of each other.

FIG. 2 is a cross-sectional side view of one power cycle module of FIG. 1.

FIG. 3 is an exploded perspective view of the adjacent air cylinder and power cylinder of FIG. 2.

FIG. 4 is a rear view of the power cylinder of FIG. 2 showing the power cylinder exhaust ports and the exhaust system in fluid communication therewith.

FIG. 5 is an enlarged side view of the air cylinder, power cylinder and fuel delivery system of FIG. 2.

FIG. 6 is a cross-sectional top view of the air and power cylinders of FIG. 5 taken along lines 6-6.

FIG. 7 is an enlarged fragmentary elevational view of the power cylinder of FIGS. 2 and 6.

FIGS. 8A, 9A, 10A and 11A are fragmentary elevational views of four embodiments of the two-barrel power cylinder of the present invention; FIG. 8A showing the embodiment of FIG. 7.

FIGS. 8B, 9B, 10B and 11B are fragmentary elevational views of four embodiments of the power cylinder pistons of FIGS. 8A, 9A, 10A and 11A, respectively; FIG. 8B showing the embodiment of FIG. 7.

FIGS. 8C, 9C, 10C and 11C are fragmentary side views of the power cylinder pistons of FIGS. 8B, 9B, 10B and 11B, respectively; FIG. 8C showing the embodiment of FIG. 7.

FIG. 12 is a cross-sectional top view of the power cylinder of FIG. 4 showing the power cylinder exhaust ports and the exhaust system in fluid communication therewith.

FIG. 13 is an enlarged view of the fuel injector housing of the fuel delivery system of FIGS. 5 and 6.

FIG. 14 is a fragmentary cross-sectional side view of the variable compression ratio mechanism as applied to the embodiment of FIG. 2.

FIG. 15 is a front view of the variable compression ratio mechanism of FIG. 14 taken along lines 15-15.

FIG. 16 is a fragmentary cross-sectional front view of the electrical ignition system as applied to an alternative power cylinder embodiment of the present invention.

FIG. 17 is a top view of the electrical ignition system of FIG. 16.

FIGS. 18A, 19A, 20A and 21A are cross-sectional front views of the air cylinder of FIG. 2 (with power cylinder in phantom) showing sequential steps of operation.

FIGS. 18B, 19B, 20B and 21B are cross-sectional rear views of the power cylinder of FIG. 2 showing sequential steps of operation corresponding to sequential steps of FIGS. 18A, 19A, 20A and 21A, respectively.

FIG. 22 is a cross-sectional elevational view of an alternative embodiment of the pumper chamber and the combustion chamber.

FIG. 23A is a top schematic view of one embodiment of a pumper piston cap.

FIG. 23B is a detail schematic view of a manifold cavity inlet in the cap of the pumper piston.

FIG. 24 is a cross-sectional elevational view of an alternative embodiment of the crankshaft and combustion piston rod.

FIG. 25 is a side view of the trunnion supporting the combustion chamber that permits variable compression.

### DETAILED DESCRIPTION OF THE PREFERRED EMBODIMENT

Reference is now made to the figures wherein like parts are designated with like numerals throughout. While the accompanying figures show the improved engine oriented vertically, i.e., the pistons moving up and down, it should be readily appreciated that the present invention may be oriented for operation in many directions. For purposes of describing and claiming the present invention on a mare general level, pistons will be described as moving inward and outward away from the head of a cylinder, rather than downward or upward, as specifically shown in the figures.

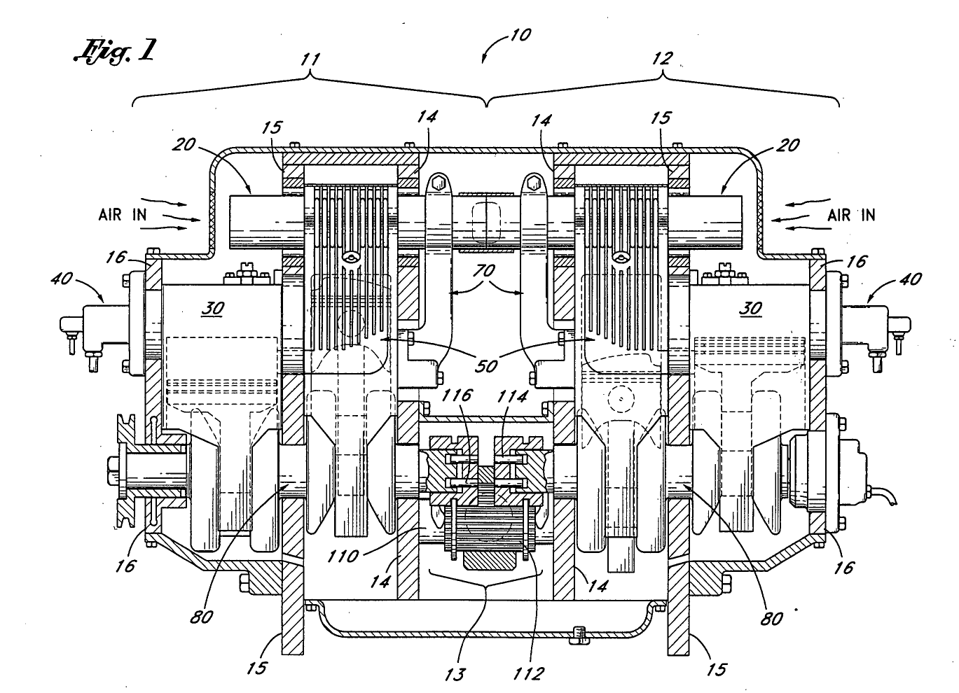

With reference to FIG. 1 and by way of broad introduction, the improved engine 10 comprises an air intake system 20 that draws fresh air into the engine 10. This air is first used to draw heat away from the combustion portion of the engine and then is delivered to an air cylinder 30 (or air cylinder, for short), for compression. The compressed air is, in part, mixed with fuel from a fuel delivery system 40 and delivered under pressure to a power cylinder 50. The balance of compressed air is delivered independently into the power cylinder 50. As described in detail below, the transfer of air and fuel from the air cylinder 30 to the power cylinder 50 is controlled by simultaneous oscillation of both cylinders which periodically brings corresponding inlet and exhaust ports into alignment. Uniquely, the air cylinder 30 and power cylinder 50 are supported by separate sets of non-linear trunnions, as described below. After delivery into the power cylinder 50, the air and fuel mixture is pressurized and ignited for combustion. Subsequent incoming fresh compressed air purges the power cylinder of “spent” gases generated from the combustion process out through an exhaust system 70. Simultaneously, the power produced by combustion of the fuel is directly transferred to a rotating crankshaft assembly 80.

Still referring to FIG. 1, the preferred embodiment of the improved invention 10 comprises side-by-side power modules 11 and 12 each of which comprise a pair of corresponding oscillating cylinders: an air cylinder 30 and power cylinder 50. Each power module 11, 12 includes three parallel and co-extensive crankcase support plates 14, 15 and 16 that support the air cylinder 30 and power cylinder 50 therebetween. Combustion of the fuel and air mixture within each power cylinder 50 of power modules 11, 12 drives rotation of crankshaft assemblies 80 which, in the embodiment of FIG. 1, are linked together via a coupler 13 of any desired configuration.

In addition, to the above combined features, the improved engine 10 of the present invention includes a variable compression ratio system 90 (not shown) that permits use of the improved engine 10 with different types of fuel and different levels of octane. The improved engine 10 also includes a unique electrical ignition system 100 (not shown) which is controlled by the oscillating motion of the power cylinder 50.

For purposes of explaining more clearly the operation of the present invention, reference is now made to the other figures. All components associated with each of the air intake system 20, air cylinder 30, fuel delivery system 40, power cylinder 50, exhaust system 70, crankshaft assembly 80, variable compression ratio system 90 and electrical ignition system 100 will now be described in respective order.

A. Air Intake System

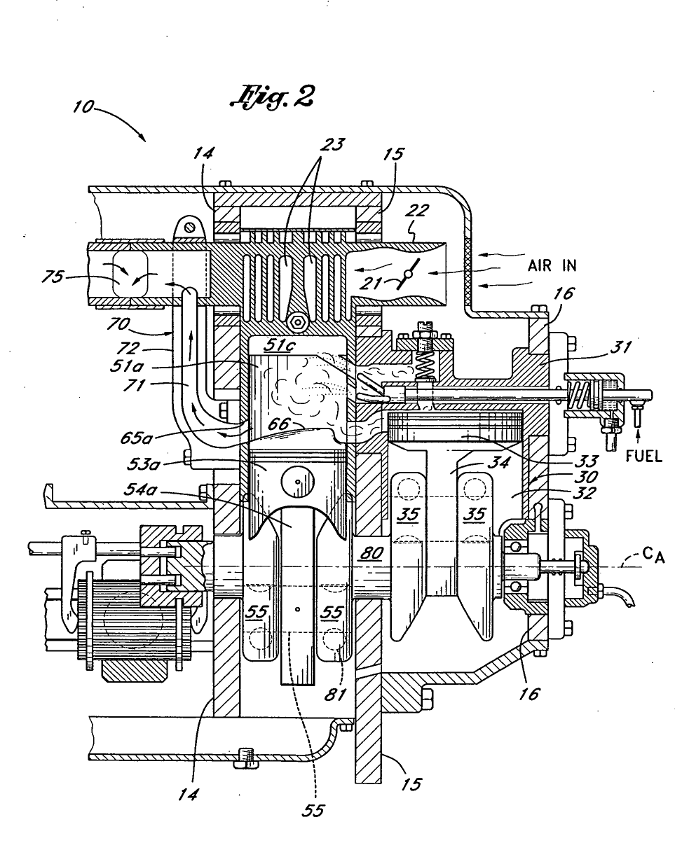

Referring now to FIGS. 2 and 3, the air intake system includes a throttle valve 21 that controls the amount of external air drawn into the engine 10. The air intake system 20 directs the incoming air into a set of power trunnions comprising a hollow tube 22 located substantially overhead of the power cylinder 50. The power trunnion tube 22 supports the power cylinder 50 in an oscillating fashion, as described in further detail below.

As best shown in FIG. 3, the air flowing into the power trunnion tube 22 is directed through openings 23 located in opposing regions of an intermediate portion of the power trunnion tube 22. The air is then directed over radiating flanges or cooling fins 24 located on the exterior surface of power cylinder 50. Air flow over the fins 24 absorbs heat from the power cylinder 50, thereby imparting a cooling effect on the power cylinder 50. This feature may be used either to supplement a separate cooling system or eliminate the requirement of a separate cooling system altogether.

Having drawn heat from the power cylinder 50, the incoming air flow then passes into passageways 25a (FIG. 3) and 25b (not shown) located on opposite regions of the power cylinder 50. The air exits the power cylinder 50 through discharge ends 26a,b of the passageways. Simultaneous oscillation of the power cylinder 50 and air cylinder 30 directs discharge ends 26a,b into alignment with corresponding apertures 27a,b (not shown) in the crankcase support plate 15 and with corresponding inlet ports 28a,b in the walls of the air cylinder 30. This allows the incoming air to be drawn into the air cylinder 30, as explained further below. The momentary, but cyclical, alignment of passageways 25a,b with apertures 27a,b and inlet ports 28a,b is best seen, in phantom, in FIG. 6.

B. Air Cylinder and Related Components

Still referring to FIGS. 2 and 3, the air cylinder 30 oscillates about a set of air trunnions 31. The air trunnions 31 are constructed integrally with the air cylinder 30 and are supported within the opposing crankcase support plates 15 and 16. Support plate 15 also supports the air inlet end of power trunnion tube 22, the other end of which is supported by crankcase support plate 14.

The air cylinder 30 comprises an air cylinder barrel 32 that houses a linearly reciprocating air piston 33. Piston 33 is rigidly affixed to an air piston rod 34 that is, in turn, movably linked to a first crank throw 35 of crankshaft assembly 80. In FIG. 2, the piston 33 is shown in its inward-most (colloquially, “top dead center”) position within barrel 32. Unlike conventional internal combustion engines, no wrist pin is included because the piston rod 34 does not move relative to piston 33.

Rotation of crankshaft assembly 80, as generated by forces from the power cylinder, causes rotation of crank throw 35 which transcribes a circular path centered about the axis of crankshaft rotation CA. This circular path, in turn, causes reciprocation of air piston 33 and piston rod 34 within the cylinder barrel 32. Because the piston rod 34 is directly and movably linked to the first crank throw 35, 360° revolution of the crank throw 35 causes the air cylinder 30 and trunnions 31 to oscillate relative to crank case support plates 15 and 16. In the preferred embodiment, the range of oscillation for the air cylinder 30 is approximately 15-25° from vertical in either direction.

As explained above, external air enters the barrel 32 of air cylinder 30 through inlet ports 28a,b shown in FIG. 3. The external air is drawn into the cylinder 30 by the partial vacuum created by the outward stroke of piston 33, although a forced air system is also contemplated. Based upon the timing of air cylinder oscillation relative to support plates 15 and 16, fresh air within the barrel 32 of cylinder 30 is then trapped. That is because oscillation of the cylinder 30 directs the inlet ports 28a,b out of alignment with passageway outlets 26a,b, thus closing off air flow. The inward stroke of the air piston 33 then compresses the air inside the cylinder 30 to high pressures.

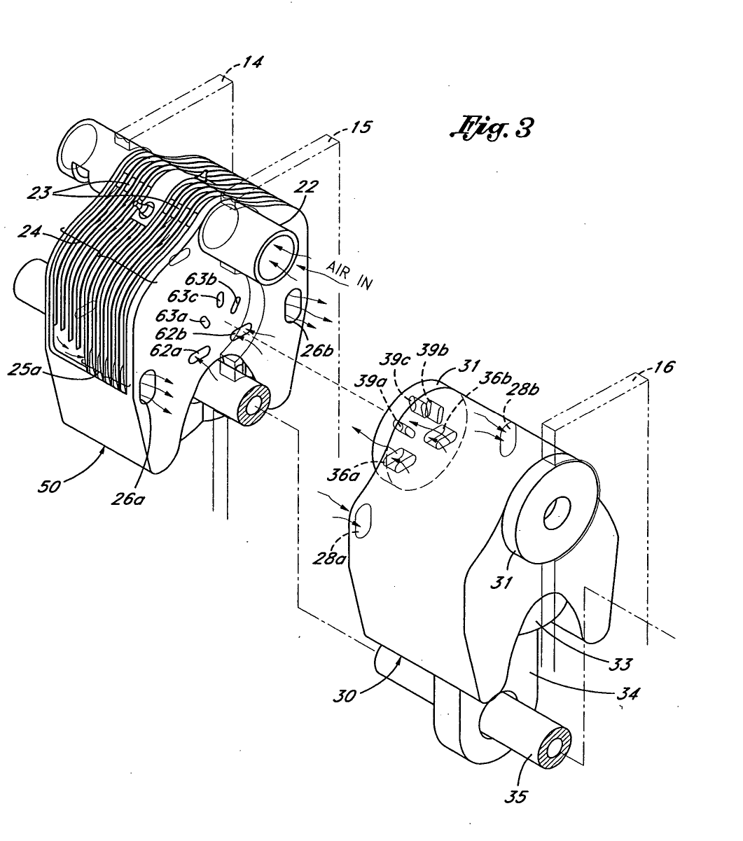

Referring now to FIGS. 3 and 5, after the air piston 33 is at its most inward position within barrel 32, a large portion of the compressed air is directed out of a first set of exhaust ports 36a (FIGS. 3 and 5) and 36B (FIG. 3 only), each located in one of the (left side) air trunnions 31. Up until that point in the cycle, the exhaust ports 36a,b are closed due to blockage by the inward-most position of power pistons in the power cylinder, as described further below. That large portion of compressed air from the air cylinder 30 flows directly into the power cylinder 50 for purposes, in part, of purging “spent” gases from the power cylinder 50.

Immediately before the large portion of compressed air is delivered to the power cylinder, a first portion of compressed air from the cylinder 30 is directed through check valves 37a (FIGS. 5 and 6) and 37b (FIG. 6) into a pre-combustion chamber 38 and temporarily stored therein. Because the exhaust ports 36a,b are closed during the inward stroke of the air piston 33, a build up of pressure occurs within the barrel of the air cylinder 30. Eventually, the pressure reaches a level sufficiently great to overcome the resisting force of the check valves 37a,b, thus permitting the delivery of air to the pre-combustion chamber 38.

As described further below, the purpose of the precombustion chamber is to temporarily hold compressed air for a time sufficient for the crankshaft assembly to rotate approximately 90 degrees past the closing of power cylinder exhaust ports. The air in the pre-combustion chamber 38 is eventually directed out through a second set of exhaust ports 39a,b (FIG. 6) and 39c (FIG. 5) and into the power cylinder 50. The second set of ports 39a-c are located in the same air trunnion 31 as the first set of exhaust ports 36a,b (see FIG. 3). The use of compressed air in the pre-combustion chamber enhances the forceful flow of fuel from the fuel delivery system into the power cylinder 50, as explained further below.

C. Fuel Delivery System

Referring to FIGS. 5, 6 and 13, the fuel delivery system 40, which injects fuel into the power cylinder 50, is concentrically aligned with the axis of rotation of the air trunnions 31 such that a portion of the fuel system is positioned within the pre-combustion chamber 38. The fuel delivery system 40 includes an axially movable tube 41 which is centrally located within an interior passageway above the air cylinder barrel 32 and between check valves 37a,b. One end of the tube 41 fits snugly within a fuel injector housing 42 that is rigidly affixed to the interior of the air cylinder head. The fuel injector housing 42 includes three discharge nozzles 43a,b (FIG. 6) and 43c (FIG. 5) that direct fuel through exhaust ports 39a-c, respectively.

The tube 41 and fuel injector housing 42 are positioned so that their longitudinal axis is coaxial with the axis of rotation TA of the air trunnions 31. Accordingly, the fuel injector housing 42 oscillates in conjunction with the air trunnions 31 as they oscillate within support plates 15 and 16.

The tube 41 moves axially relative to the fuel injector housing 42 pursuant to the force exerted by a hydraulically controlled fuel piston member 44. The piston 44 moves linearly under the countervailing forces of hydraulic fluid 45 pressurized by a master cylinder at gas pedal location (not shown) and an opposing helical spring 46.

Referring specifically to FIGS. 6 and 13, the tube 41 and the housing 42 each have corresponding set of openings 47a,b and 48a,b that overlap to a greater or lesser degree depending upon the axial position of the tube 41 relative to the fuel injector housing 42. The tube openings 47a,b consist of slots that are preferably tapered. Due to the tapered geometry of slots 47a,b, axial movement of the tube 41 relative to the housing 42 determines the amount of fuel delivered through the discharge nozzles 43a,b because it directly changes the area of overlap of openings 47a,b and 48a,b. As should be readily apparent, when the openings 48a,b overlap the larger end of tapered openings 47a,b, the fuel flow is greater than when openings 48a,b overlap the smaller end of tapered openings 47a,b.

While axial movement of tube 41 relative to the fuel injector housing 42 controls the volume of flow, oscillation of the air cylinder 30 and fuel injector housing 42 relative to tube 41 turns fuel flow on or off. That is because the mating sets of openings 47 and 48 in the tube 41 and the housing 42, respectively, are sufficiently small that they are in alignment only periodically. When properly timed, the oscillating motion of the air cylinder 30 allows fuel from nozzles 43a-c to be directed, along with air from the precombustion chamber 38, through the second set of exhaust ports 39a-c in air cylinder 30.

The tube 41 and housing 42 also have a third set of corresponding openings 47c and 48c, respectively. This latter set of openings controls flow to nozzle 43c (FIG. 5) and permits continuous flow through nozzle 43c into the power cylinder for purposes of maintaining the engine at an idling level. Because the openings 47c and 48c are positioned coaxially with the axis of oscillation and at the end of the tube 41, neither the oscillation of the air cylinder 30 nor reciprocation of the tube 41 will cutoff flow into nozzle 43c.

The air and fuel are forcefully directed into the power cylinder 50 at high pressure to mix with the previously delivered fresh air for purposes of combustion. Dividing the fuel into separate streams and delivering the fuel with compressed air from the pre-combustion chamber 38 advantageously encourages efficient mixing of the air and fuel to enhance combustion.

D. Power Cylinder and Related Components

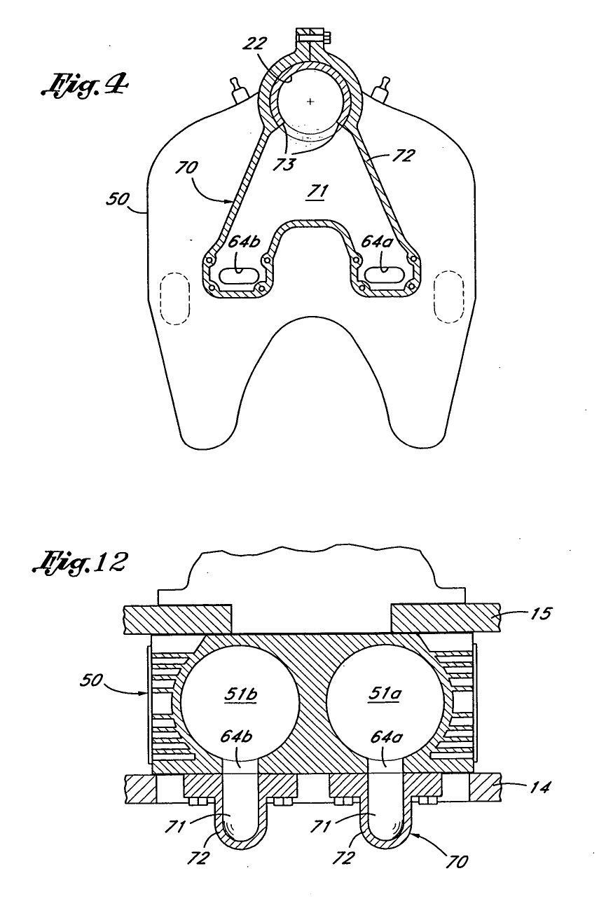

Referring now to FIGS. 2 and 7, the power cylinder 50 can be described in greater detail. Power cylinder 50 oscillates with the power trunnion tube 22 that is spaced apart from, and parallel to, the set of air trunnions 31 (FIG. 2). The power trunnion tube 22 oscillates within openings in crank case support plates 14 and 15.

The power cylinder 50 comprises two separate barrels 51a,b, separated by a chamber wall 52. Above the chamber wall 52 is a common combustion chamber 51c where combustion of the fuel and air mixture occurs. Each barrel houses a power piston 53a (or 53b, FIG. 7) that is mechanically linked to a piston rod assembly. It is also contemplated that the piston be rigidly joined to the piston rod assembly, either as discrete components connected in a non-movable fashion or as a single unitary component having no mechanical connection therebetween.

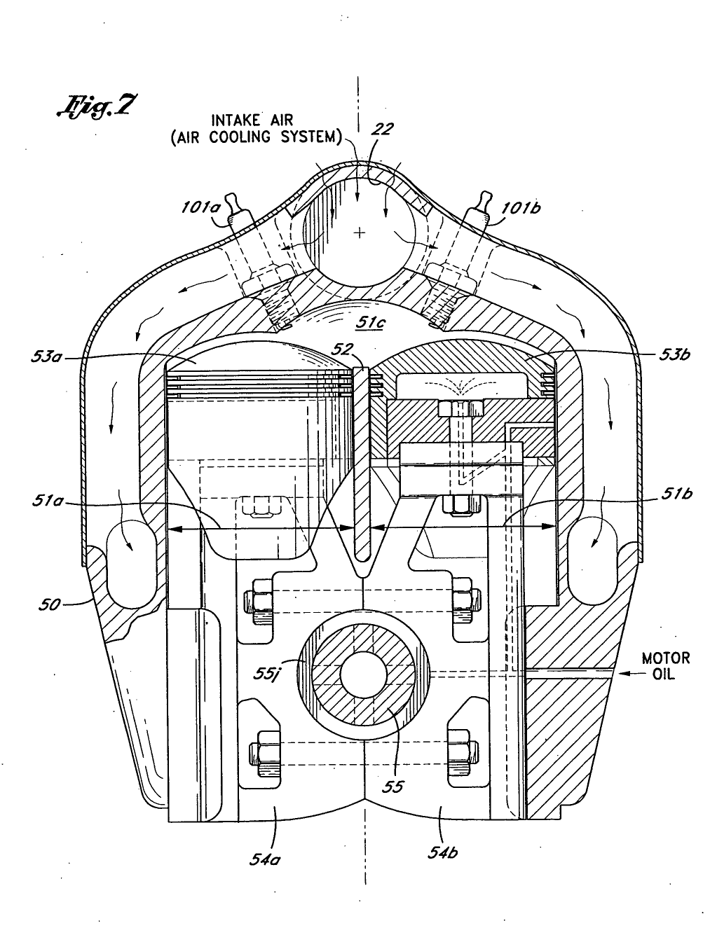

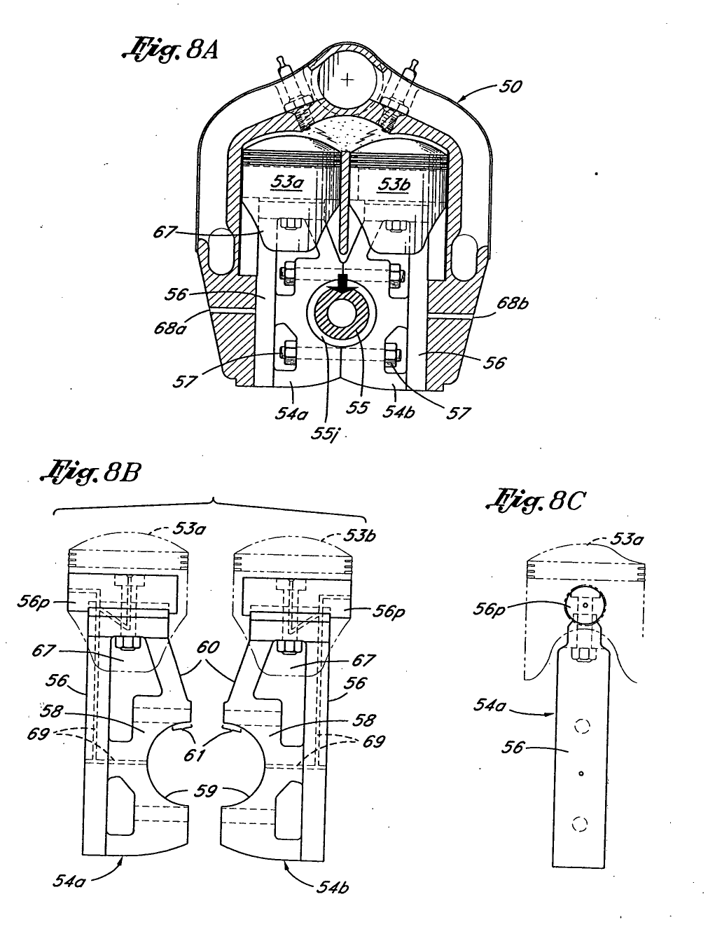

With regard to the embodiment of FIGS. 2 and 7, the piston rod assembly preferably comprises two discrete piston rods 54a,b. (Alternative piston rod assemblies are described below in association with FIGS. 9-11). Like the air piston rod 34 of air cylinder 30, the power piston rods 54a,b are movably coupled to a second crank throw 55 of crankshaft assembly 80 via journal 55j. The power piston rods 54a,b are rigidly joined to each other in one of several selected arrangements, as described further below, such that the mechanically joined rods 54a,b enclose the second crank throw 55 in rotating engagement. This arrangement permits mechanical forces generated from combustion to be transferred through the piston rods 54a,b to the crank throw 55 while permitting rotation of the crank throw 55 within the journal 55j. In response to these forces, the crank throw 55 transcribes a circular path about an axis of rotation CA (FIG. 2) of the crankshaft assembly 80, thereby causing oscillation of the power cylinder 50 with the power trunnion tube 22 within support plates 14 and 15. In the preferred embodiment, the oscillating power cylinder 50 transcribes an arc in the range of 10-20° on either side of the vertical axis.

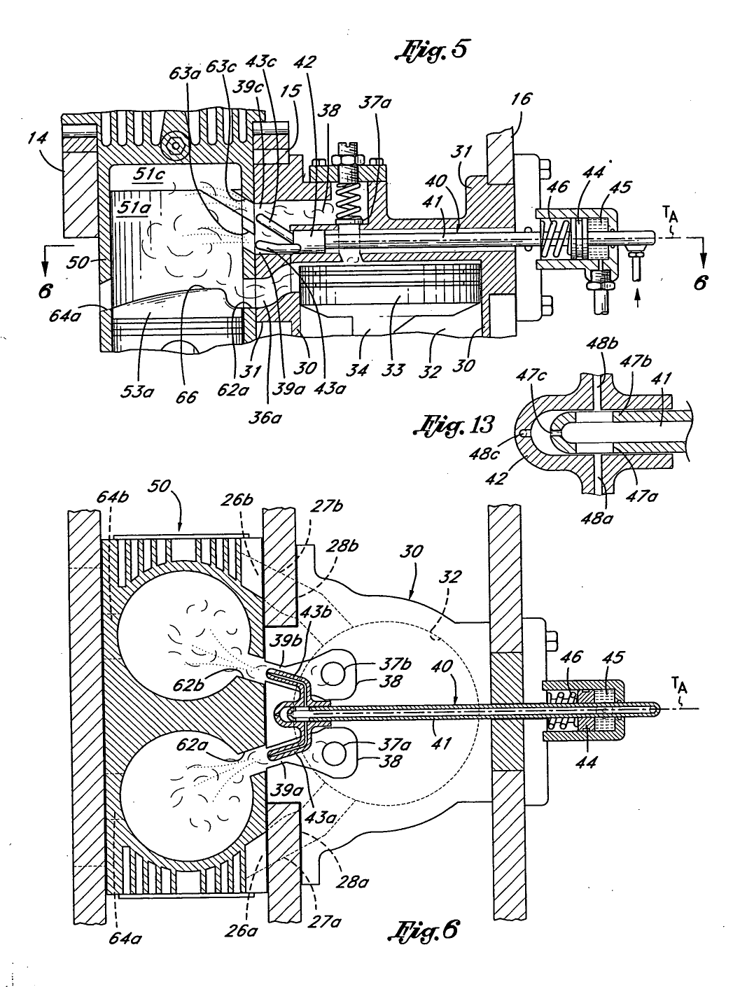

Referring to FIGS. 8A, 8B and 8C together, the first embodiment of power cylinder components, also shown in FIG. 7, can be described in even greater detail. Each piston rod 54a,b consists of an elongate member 56 that extends below the pistons 53a,b, as shown more prominently in FIG. 8B. The piston rods 54a, b are connected to the pistons 53a, b via pins 56p. The elongate members 56 are connected to each other by mechanical fasteners such as bolts 57 (FIG. 8A) that extend through flanges 58 about an opening 59 (FIG. 8B). The opening 59 is sized to fit about the journal 55j and the power crank throw 55 in a rotationally engaging manner. The piston rod 54a,b also include an angled member 60 (FIG. 8B) that extends between the corresponding power piston 53a,b and the opening 59 for the crank throw 55.

A significant feature of this embodiment is that the angled members 60 allow some of the force from the dual power pistons 53a,b to be transferred directly to the power crank throw 55 through regions 61. This causes the downward force of the dual power pistons 53a,b to “push” the power crank throw 55 of the crankshaft assembly 80 downwardly during the power stroke of the power cylinder 50, as shown by the bold arrow.

An alternative embodiment of the power cylinder piston rod assembly is illustrated in FIGS. 9A-C in which the two pistons 153a,b are rigidly affixed via pins 154p to a unitary first connecting link 154a that spans the diameter of the base of the power cylinder below the barrel dividing wall 152. The first connecting link 154a is mechanically connected to a second connecting link 155b by mechanical means such as bolts 157 shown in phantom. Both connecting links 154a,b have mating semicircular channels to form an opening 159 that encircles a crank throw journal 155j and crank throw 155 (FIG. 9B). The downward movement of the dual power pistons 153a,b “pushes” the power crank throw 155 downwardly during the power stroke of the power cylinder 150, as shown by the bold arrow.

Returning back to FIGS. 3 and 5, other components of the power cylinder can be described. Referring first to FIG. 3, it can be seen that air cylinder exhaust ports 36a,b and 39a-c mate with corresponding sets of inlet ports 62a,b and 63a-c in the power cylinder 50, respectively. FIG. 5 shows exhaust port 36a mating with inlet port 62a and exhaust port 39a mating with inlet port 63a. The other ports not shown are positioned directly behind those shown, as appreciated from FIGS. 3 and 6. FIG. 5 also shows exhaust port 39c mating with inlet port 63c, wherein inlet port 63c extends up through barrel wall 52 into combustion chamber 51c. With this arrangement, a certain amount of fuel and air is delivered through power cylinder inlet ports 63a, b into to separate barrels 51a,b, respectively. Fuel and air is also delivered, through nozzle 43c (FIG. 5), directly to the combustion chamber 51c.

As can now be appreciated, oscillation of the power cylinder 50 and the air cylinder 30 periodically aligns the two sets of power cylinder inlet ports with the two sets of air cylinder exhaust ports to control the flow of air between cylinders. However, it must be understood that inlet ports 63a-c (FIG. 3) and exhaust port 39a-c cannot be in alignment at the same time that inlet ports 62a,b and exhaust ports 36a,b are in alignment. Otherwise, air from the air cylinder and the air/fuel from the pre-combustion chamber would enter the power cylinder at the same time. This is not desired because fuel may be inadvertently lost from the power cylinder prior to combustion. If properly timed, the delivery of air from the pre-combustion chamber 38 to the power cylinder 50 should occur only after the large portion of air from the air cylinder 30 has entered the power cylinder through inlet ports 62a,b and has purged the power cylinder 50 of spent gases. These spent gases are directed out of the power cylinder 50 through exhaust ports 64a,b (FIGS. 4 and 5). By this time, the power piston 53 has moved sufficiently inward within the power cylinder 50 to close off inlet ports 62a,b and exhaust ports 64a,b, permitting the introduction of air/fuel from the pre-combustion chambers.

The flow of air either entering through the inlets ports 62a,b or exiting the exhaust ports 64a,b is controlled not only by simultaneous oscillation of the air cylinder 30 and the power cylinder 50, but also by the reciprocating movement of power pistons 53a,b through barrels 51a,b. When each of the power pistons 53a,b is at or near its outward-most position (“bottom dead center”) of the power cylinder 50, the incoming fresh air charge is able to flow through inlets 62a,b into the power cylinder 50. Simultaneously, the exhaust gases are able to exit the cylinder through exhaust ports 64a,b. As the power pistons 53a,b begin to move inward, they block the inlet ports 62a,b and the exhaust ports 64a,b in the power cylinder 50. The inlet ports 62a,b and exhaust ports 64a,b remain closed during all inward movement of the power pistons 53a,b because an annular piston skirt 67 (FIGS. 2 and 7) extending outwardly from each power piston covers these inlet and exhaust ports. The alternative embodiment of FIG. 9A shows pistons 153a,b with a similar skirt 168. While FIG. 2 shows the exhaust ports positioned distal from the power trunnion conduit 22, permitting two-stroke application, the present invention contemplates locating one or more exhaust ports closer to the inward-most portion of the power cylinder 50 so that the engine can be operated in a four-stroke fashion, if properly timed. In the latter case, closing of the exhaust ports would depend purely upon oscillation of the power cylinder relative to the exhaust system 70, rather than reciprocation of the power pistons relative to the exhaust ports.

As best seen in FIG. 5, power pistons 53a,b each include a raised ridge 66 that acts as a baffle and enhances the removal of the spent gases from the power cylinder 50. The surface of each piston 53a or 53b contains a steeply sloped surface below the raised ridge 66 and proximate the inlet ports 62a, b to direct the air inwardly towards the head of the power cylinder 50. This causes the fresh air to circulate throughout the power cylinder 50, scavenging the exhaust gases out exhaust ports 64a,b. The raised ridge 66 also serves the purpose of more effectively dispersing the fuel entering through inlet ports 53a and 63b, which enhances mixing of the fuel and air and increases efficient combustion of the fuel. As the fuel enters the power cylinder, that portion of the fuel delivered through inlet ports 63a and 63b into barrels 51a and 51b, respectively, strikes the ridge 66 and disperses.

E. Exhaust System

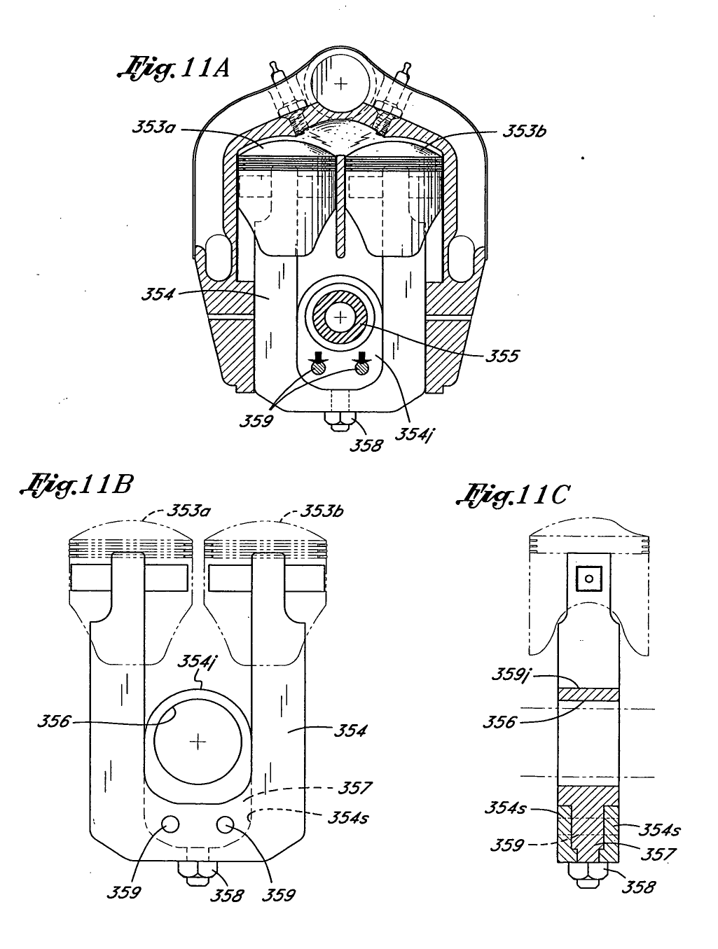

As seen in FIGS. 2, 4 and 12, the exhaust ports 64a,b are connected to the exhaust system 70. The exhaust system 70 comprises a single passageway 71 in conduit member 72 that directs the spent gases from the power cylinder 50 to an opening 73 in the power trunnion tube 22. The conduit member 72 is securely fastened to the power cylinder 50 by mechanical fasteners such as bolts 74. The spent gases traverse the passageway 71, enter the power trunnion tube 22 at opening 73, and exit the power trunnion tube 22 through engine exhaust opening 75. The exhaust gases are then directed away from the engine 10. Reference is also made to FIG. 1, where exhaust from two separate power modules 11, 12 is manifolded together in a single shared power trunnion tube 22.

Referring to FIGS. 8A and 9A, the improved engine 10 also includes a plurality of passageways in the power cylinder 50 to promote the flow of oil within the cylinder.

With the embodiment of FIG. 8A, the oil enters the power cylinder 50 through inlet ports 68a,b and is directed inwardly to the piston rods 53a,b. With the embodiment of FIG. 9A, oil enters the power cylinder 150 through inlets 168a,b and is directed inwardly to the connecting links 154a,b.

Referring now to FIG. 8B, the oil travels through the piston rods 54a,b through passageways 69 shown in phantom. With this arrangement of passageways as shown, oil can be delivered to piston pins 56p, piston skirts 67 and crank throw journal 55j (FIG. 8A). It is contemplated that the embodiment of FIG. 8B also includes opposing piston buttons (not shown) positioned on opposite sides of the piston pins 56p. These buttons will be slidable within the pins under the pressure of the oil to assist in maintaining alignment of the pistons as they reciprocate within the oscillating power cylinder.

Referring to the alternative embodiment of FIG. 9B, oil is directed to the connecting links 154a,b through passageways 169 formed by the junction of the connecting links 154a,b. Channels 169 direct the oil to pins 154p, piston skirts 168 and crank throw journal 155j (FIG. 9A).

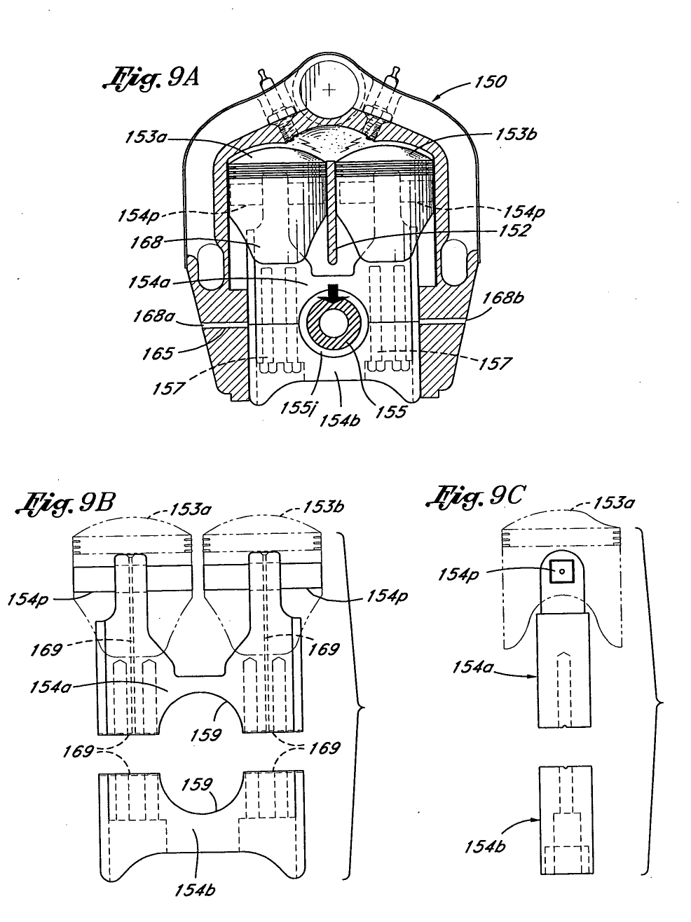

Two other embodiments of power cylinder piston rod assemblies are contemplated beyond those shown in FIGS. 8A and 9A. Referring now to FIGS. 10A-C and 11A-C, it can be seen that the two pistons 253a,b are jointly supported by a unitary “U”-shaped piston rod 254. Referring first to FIGS. 10A-C, the “U”-shaped piston rod 254 is connected to a journal 254j that movably engages the power crank throw 255 by way of opening 256 (FIG. 10B). FIGS. 10B and 10C show that the journal 254j includes downwardly extending flanges 257 that straddle a seat 254s on the “U”-shaped piston rod 254. The “U”-shaped piston rod 254 and journal 254j are securely connected by mechanical fasteners such as bolts 258 (shown in phantom).

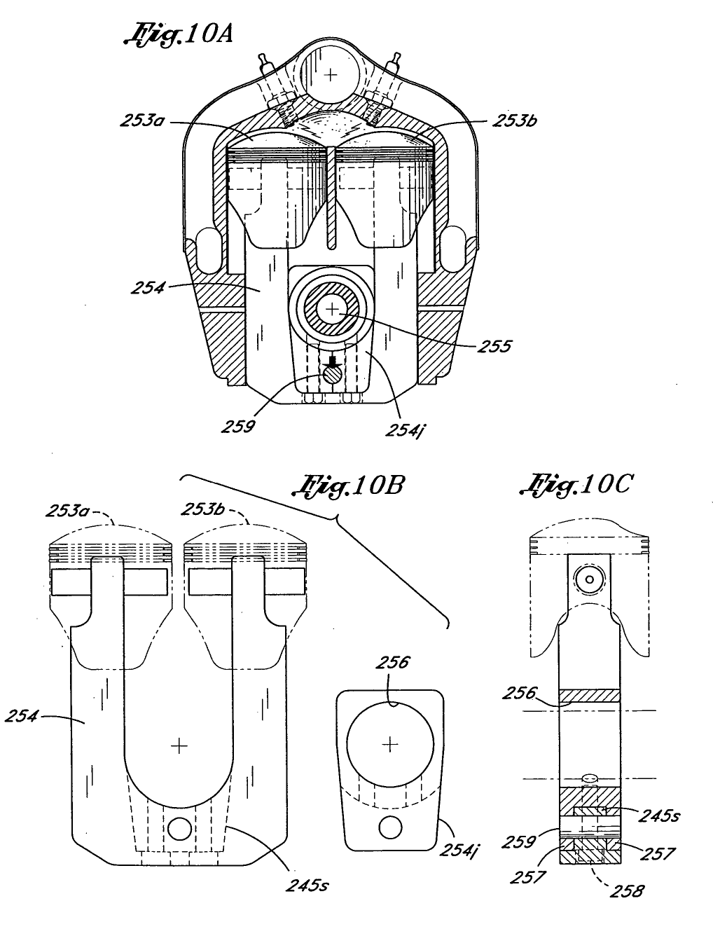

Referring back to FIG. 10A, during operation, the downward movement of the dual power pistons 253a,b causes the U-shaped piston rod 254 to simultaneously move outward. The outward force of the U-shaped piston rod 254 is transmitted to the journal 254j via a pin 259 and ultimately to the power crank throw 255 of the crankshaft assembly (not shown). Thus, as indicated by the arrow, the outward force of the dual power pistons 253a,b “pulls” the crank throw 55 downwardly through U-shaped piston rod 254 and journal 254j, rather than pushing it down as accomplished by the embodiments of FIGS. 8A-C and 9A-C. The embodiment of FIGS. 11A-C operates similarly.

Referring now to FIGS. 11A-11C, it can be seen that this embodiment similarly comprises a U-shaped piston rod 354 and journal 354j that are mechanically secured to each other by a bolt 358. The U-shaped piston rod 354 has a seat 354s which engages both sides of a flange 357 extending downward form journal 354j. The journal 354j and U-shaped piston rod 354 are aligned by passing pins 359 through holes in the flange 357 of journal 354j and the seat 354 of U-shaped piston rod 354. The embodiment of FIGS. 10A-C is different from the embodiment of FIGS. 1A-C in the configuration of the seat and journal.

F. Power Cycle Operation

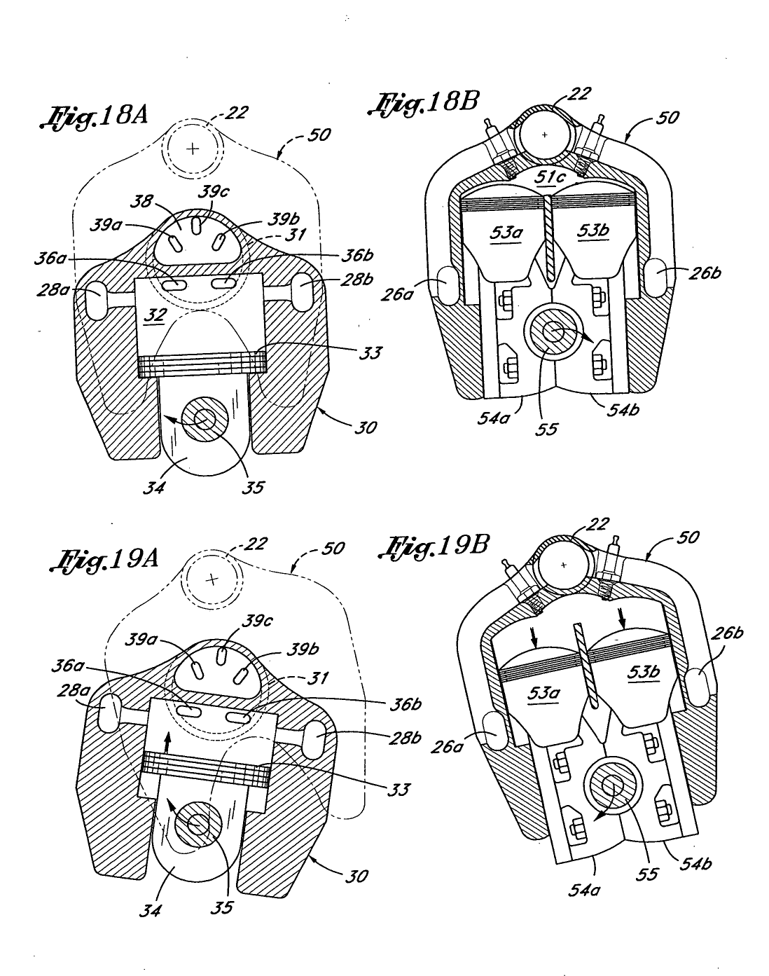

Now that the components associated with the air cylinder 30 and power cylinder have been described, cyclical operation of the reciprocating pistons within each cylinder, as well as simultaneous oscillation of both cylinders, can now be described more effectively. Reference is now made to FIGS. 18A,B-21A,B. Specifically, FIGS. 18A, 19A, 20A and 27.A show the position of both the air cylinder 30 and the air piston 33 relative to the air crank throw 35 during the four steps of the power cycle. The power cylinder is shown in phantom. FIGS. 18B, 198, 20B and 21B illustrate the corresponding position of the power cylinder 50 and the dual power pistons 53a,b relative to the power crank throw 55. The illustrations of FIGS. 18B, 19B, 20B and 21B show the power cylinder as viewed from the air cylinder, as is apparent by comparing these figures with the phantom portion of FIGS. 18A, 19A, 20A and 21A. Together, these four figures illustrate one power producing cycle or, in other words, one 360° rotation of the crankshaft assembly 80.

As seen in FIG. 18A, the power cycle will be assumed to begin with inlet of fresh air into the air cylinder 30 through inlets 28a,b. The air cylinder 30 and the power cylinder 50 are aligned at this time. The air piston 33 is at the bottom dead center position of the air cylinder 30. By comparison with FIG. 18B, it is clear that the air piston 33 is 180° out of phase with the power pistons 53a,b which are positioned at the top dead center of the power cylinder 50 at this time. It can be appreciated that as air enters the air cylinder 30 through inlets 28a,b, combustion takes place in the combustion chamber 51c at the inward-most portion of the power cylinder 50.

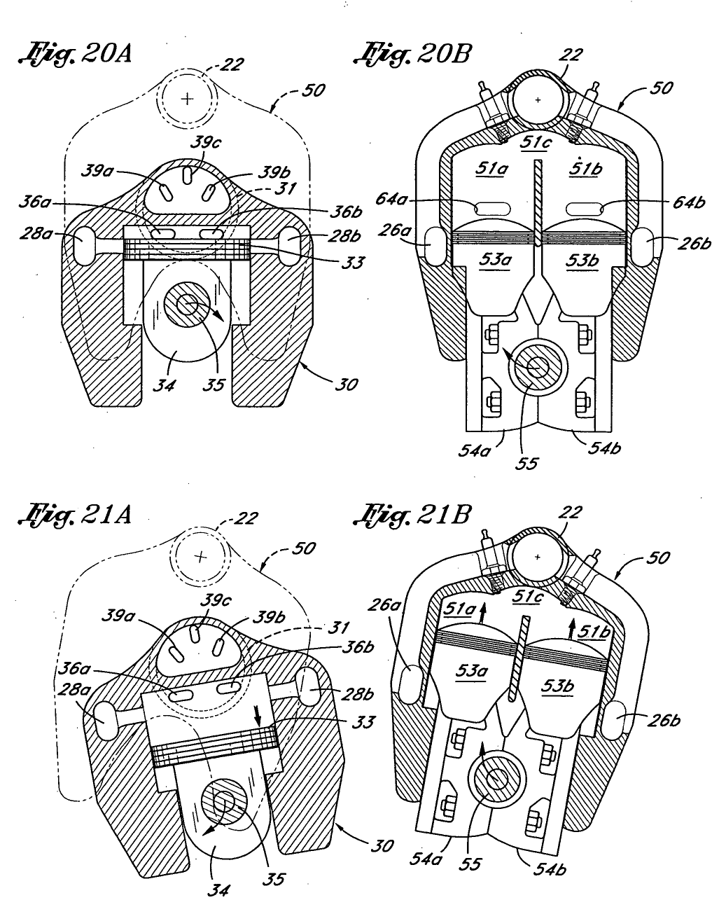

As shown in FIG. 19A, as the power cycle begins, the air cylinder 30 fills with a fresh air charge and the air piston 33 begins to move inward as the air crank throw 35 rotates clockwise. Oscillation of the air cylinder 30 takes the inlet ports 28a,b of air cylinder 30 out of alignment with air passageway ports 26a,b of power cylinder 50, thus preventing further flow of air into the air cylinder. The air within the air cylinder 30 is then compressed by inward movement of the air piston 33.

At the same time, as seen in FIG. 19B, the force provided by the expansion of the ignited fuel and air mixture in combustion chamber 51c causes the dual power pistons 53a, b to move outwardly in the power cylinder 50. Simultaneously, the power cylinder 50 oscillates with the power trunnion tube 22, tracking clockwise movement of the power crank throw 55.

As appreciated from FIGS. 20A and 20B, when the power pistons 53a,b are at their bottom dead center position in the power cylinder 50 and the air piston 33 is at its top dead center position in the air cylinder 30, the power cylinder 50 and the air cylinder 30 are again aligned and parallel. The first set of exhaust ports 36a,b in the air trunnion 31 adjacent the power cylinder 50 becomes aligned with inlet ports 62a,b (not shown) of the power cylinder 50. This allows a large portion of the compressed air in the air cylinder 30 to flow rapidly into the barrels 51a,b of power cylinder 50. At the same time, a certain amount of compressed air in the air cylinder is directed into pre-combustion chamber 38 above barrel 32. Because the power pistons 53a,b are at their outward-most point, the exhaust ports 64a,b (FIG. 4) are exposed permitting the incoming air from the air cylinder 30 to purge spent gases out of power cylinder 50 through the exhaust ports 64a,b.

As shown in FIGS. 21A and 21B, as the power pistons 53a, b move inward from their bottom dead center position, the power cylinder 50 oscillates with power trunnion tube 22. As the power cylinder and air cylinder again oscillate out of alignment, the air cylinder exhaust ports 39a-c fall into alignment with power cylinder inlet ports 63a-c (not shown), permitting fuel and some additional pressurized air to enter the power cylinder from the pre-combustion chambers 38a,b. At that point, spent gases have been purged and power cylinder exhaust ports 64a,b are closed, preventing any inadvertent loss of fuel out the exhaust system 70. The corresponding ports 39a-c and 63a-c remain in alignment only momentarily so that, by the time the power pistons 53a,b are at their most inward point, these ports are closed during combustion. The inward movement of the power pistons 53a,b compress the air in the barrels 51a,b and combustion chamber 51c until the power pistons 53a, b reach their top dead center position and the power cylinder 50 is again ready for ignition and combustion (FIG. 18B). Simultaneously, the air piston 33 moves fully outward to eventually draw fresh air into the air cylinder 30 (FIG. 18A).

Operation of the oscillating cylinders in the unique arrangement of the present invention should now be sufficiently understood. One should readily appreciate the importance of timing with the present invention to maximize the purging of all spent gases with only a minimal loss of fresh incoming gases prior to combustion. If timed correctly, no fuel loss should be experienced before combustion as well.

As appreciated from FIG. 7, a significant feature of the first preferred embodiment of the improved engine 10 is the pressure or force upon each power piston 31 from the combustion of the fuel is equal because the dual power cylinders 50 share a common combustion chamber 51c. This causes the internal forces and loads from the engine's operation to be balanced and act equally on the dual power pistons 53a,b. Additionally, the oscillating motion of the cylinders 50 causes the force on each power pistons 53a,b to be directed through the centerline of each of the power piston rods 54a,b. The force on the power crank throw 55 of the crankshaft assembly 80 is also balanced because the power piston rods 54a,b act equally upon the power crank throw 55, as described above.

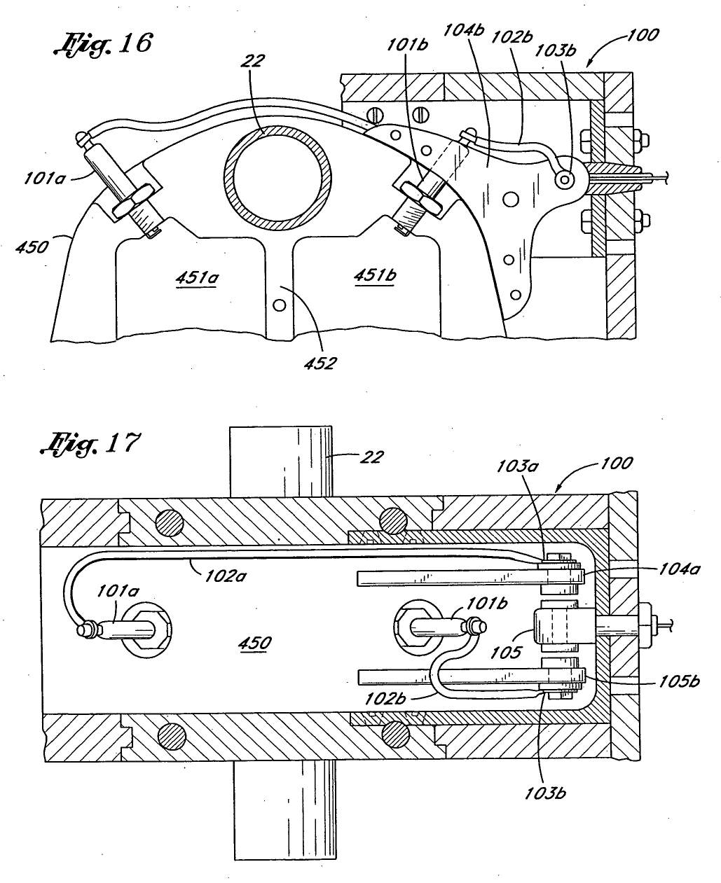

Referring momentarily back to FIG. 16, another embodiment of the power cylinder is illustrated. There, a different power cylinder 450 is illustrated including separate barrels 451a,b each of which has its own separate combustion chamber separated by a dividing wall 452 extending all the way up to the head of the cylinder. Even with this arrangement, the power pistons (not shown) may still be interconnected by power piston rods located on each side of the power crank throw, as described above in association with FIGS. 7-11C.

G. Alternative Air/Fuel Delivery System

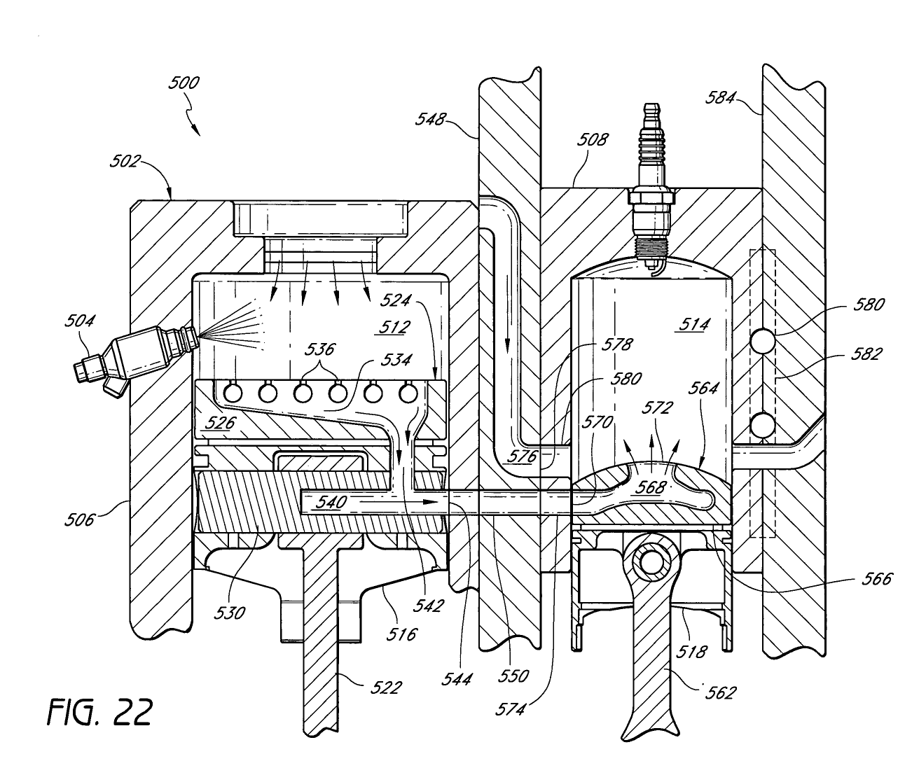

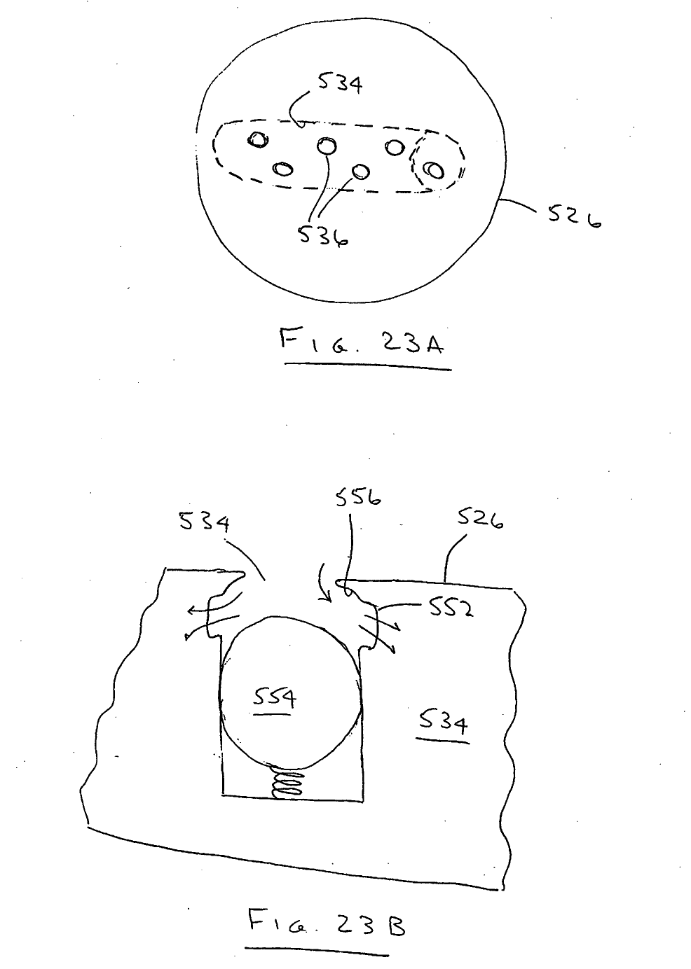

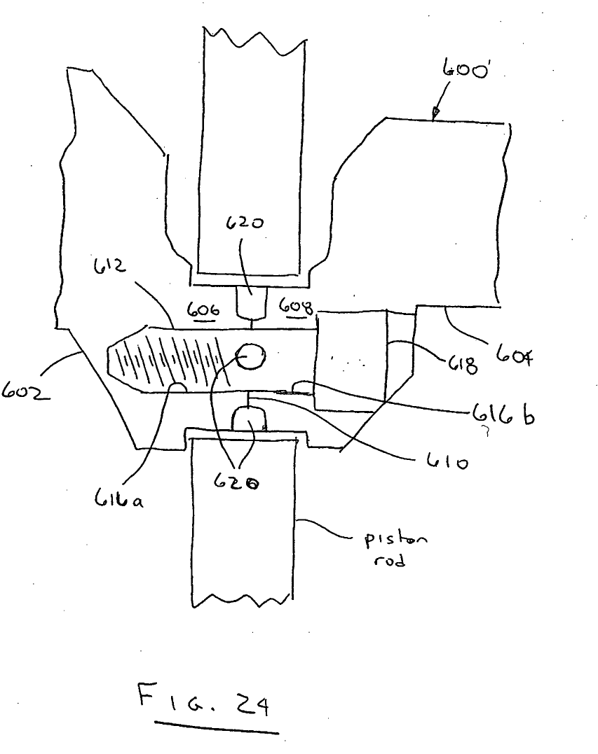

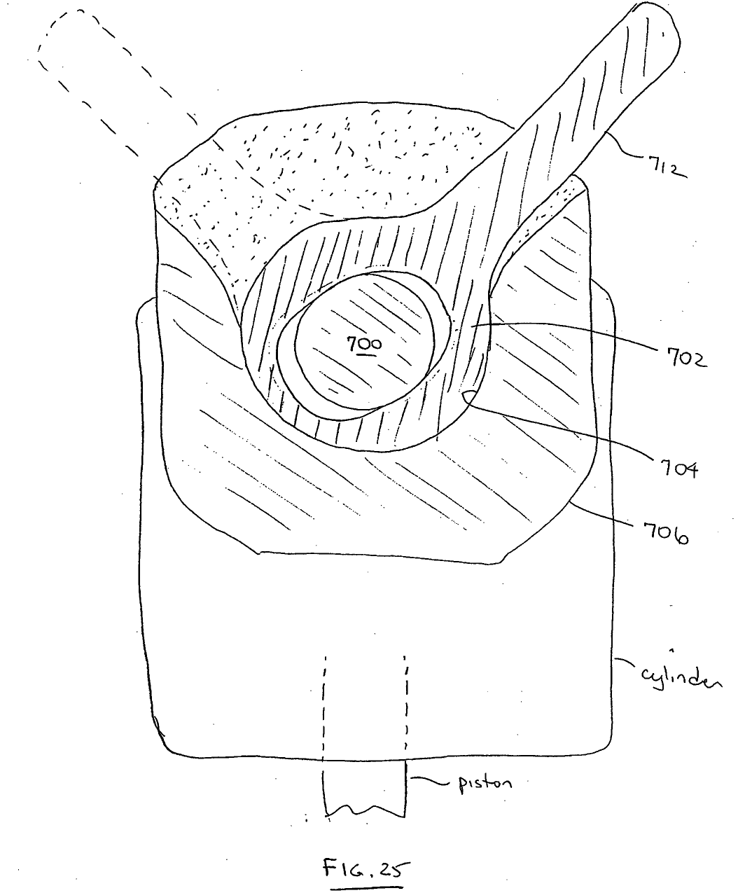

With reference to FIGS. 22, 23A and 23B, an alternative embodiment of an oscillating engine 500 with an alternative air/fuel delivery system 502 may be described that improves fuel usage efficiency by vaporizing the fuel for greater dispersion prior to combustion. While other arrangements are contemplated, one embodiment of an alternative air/fuel delivery system 502, which delivers a mixture consisting of air mixed with fuel from a fuel injector 504, comprises features within an oscillating pumper cylinder 506 and a combustion cylinder 508 positioned adjacent to each other. Within the pumper cylinder 512 is a pumper chamber 512 that houses pumper piston 516 to compress a mixture of fuel and air for delivery to a combustion chamber 514 within the combustion cylinder 508, within which resides a combustion piston 518 for combustion of the air and fuel mixture. The pumper piston 516 comprises a piston rod 522 that reciprocally drives piston head 524, which itself comprises a pumper piston cap 526. Preferably, the piston cap 526 has a domed configuration to enhance swirling of air and fuel during compression. In this embodiment, the pumper piston head 524 preferably is carried by, and moves radially relative to, the pumper piston rod 522 by way of a wrist pin 530.

Referring specifically to FIGS. 22 and 23A, the pumper piston cap 526 comprises a manifold cavity 534 having a plurality of inlets 536 for receiving a charge of fuel and air mixture from within the pumper cylinder 512 upon compression by the pumper piston 516. Preferably, the manifold cavity 534 is arranged as shown in FIG. 23A in a somewhat elongate fashion with the inlets 536 also arranged as shown. However, it is contemplated that the manifold cavity may be shaped differently and the inlets arranged differently without significantly sacrificing the function achieved by the manifold cavity.

The manifold cavity 534 is fluidly linked to a storage cavity 540 within the wrist pin 530 via a bore 542 in the pumper piston head 524. The storage cavity 540 is arranged axially within the wrist pin 530 and comprises an outlet 544 that mates with a corresponding opening in the pumper cylinder 506 for delivery of the air/fuel mixture to the combustion chamber 512. In the support wall 548 that supports the pumper cylinder 506 in an oscillating manner and the combustion cylinder 508 in an oscillating manner there is a corresponding aperture 550 for permitting the transfer of air/fuel mixture between cylinders. The storage cavity 540 is positioned so that outlet 544 becomes aligned with aperture 550 at a lower portion of the downstroke of the pumper piston 516 within the pumper chamber 510. The stroke of the pumper piston 516 is preferably, but not need be, 1⅜ inches. Other stroke lengths could be used and still work effectively.

Referring to FIG. 23B, each inlet comprises a bore having side outlets 552 in which the bore houses a check valve that is configured to regulate the introduction of air/fuel mixture into the manifold cavity 534 during the upstroke of the pumper piston. Preferably, the check valve comprises a spring loaded ball valve 554 that is normally seated against a matingly configured opening 556 of each inlet 536. The spring loaded valve 554 is configured to resist the introduction of air/fuel mixture until sufficient pressure has developed within the pumper chamber 510 based upon the compression of the air and fuel by the pumper piston 516. When a threshold pressure has been met, the compressed air/fuel mixture is forced through the inlets 536 in the pumper piston cap 526, through the manifold cavity 534 and into the storage cavity 540.

With reference to FIG. 22, the combustion cylinder 508 comprises a combustion piston 560 within the combustion chamber 512, the chamber having a volume that is preferably but not necessarily about twice that of the pumper chamber volume. Other relative chamber volumes are contemplated and would still operate effectively. The combustion piston 560 comprises a piston rod 562 and a piston head 564, which includes a piston head cap 566. Within the head cap 566 is a delivery cavity 568 having an inlet 570 and an outlet 572. The delivery cavity inlet 570 is positioned to align with a first aperture in the combustion cylinder 508 and also with the wall aperture 550 at a lower portion of the downstroke of the combustion piston 560, preferably at bottom dead center, so that the compressed air/fuel mixture temporarily stored in the storage chamber 540 can be directed into the delivery cavity 568 and then into the combustion chamber 512. Outlet 572 of the delivery cavity 568 is preferably configured to maximize the dispersion of the air/fuel mixture within the combustion chamber 512.

With the above arrangement, enhanced fuel efficiency may be realized, in part due to the enhanced vaporization of fuel prior to combustion. By injecting fuel into the pumper chamber 510 via a spray injector 504, the fuel is initially vaporized. The swirling action of the air and fuel mixture generated by the compression of the mixture by the domed piston cap 526 further leads to dispersed fuel and/or further vaporization. Forcing the fuel under great pressure in the pumper chamber 510 into the manifold cavity 534 through a plurality of inlets 536 also adds to the dispersion and/or vaporization of the fuel. By further directing the mixture through the storage and delivery cavities 540, 568 and into the combustion chamber 512, the fuel is further vaporized and/or dispersed, leading to equivalent power of a comparable size engine with less fuel utilization. If desired, fuel delivery in the present embodiment may be supplemented and/or replaced by an auxiliary fuel injection system positioned above the pumper cylinder 506 whereby fuel is added to incoming air prior to introduction into the pump chamber 510. It should also be noted that the present fuel efficiency enhancing features may be applicable to an engine having non-oscillating cylinders, where fluid communication between the pumper piston cap and the combustion piston cap depend upon reciprocation without oscillation.

Operation of the above engine embodiment is preferably enhanced by the application of a blower (not shown) for delivering pressurized air to the combustion chamber 512 to purge exhaust gases from the chamber as the new charge of air and fuel is delivered to the chamber permitting a faster exchange of exhaust and refreshed charge. The blower is preferably powered by the crankshaft (not shown) in any manner that one of ordinary skill in the art will appreciate. Preferably, the blower is also powered during start up by an auxiliary motor that drives the blower initially to enhance its effectiveness in forcing exhaust out of the combustion chamber. As shown in FIG. 22, air from the blower is delivered through a channel 576 in the support wall 548 and out an outlet 578 of the wall that aligns with a second aperture 580 in the combustion cylinder 508 when the oscillating combustion cylinder 508 reaches a certain position during oscillation. At the point, the combustion piston 560 is a bottom dead center so that the blower air purges the exhaust from the combustion chamber 508 as new charge is released. This arrangement also has the advantage of permitting the blower air to purge the delivery cavity 568 of any residual exhaust that may have back flowed into the cavity following combustion and before the cavity is recharged with a new air and fuel mixture.

Preferably, means for providing a misted supply of water to the blower discharge line that draws heat from the engine will serve to crack some of the water to generate hydrogen from the water molecules. The hydrogen is then delivered as part of the blower supply to the combustion chamber to enhance combustion. One of ordinary skill in the art will appreciate that any known fluid directing arrangement can be used to draw misted water over the cylinders for purposes of heating the water prior to introduction into the blower discharge line.

Referring to FIG. 22, an optional feature may be provided to facilitate reciprocation of the piston within the combustion and pumper chamber. Specifically, in one embodiment, at least one roller 580 is provided on each side of the piston rod that rides axially within the chamber in a groove 582 in the side wall of the cylinder. If desired, more than one roller on each side may be provided.

The present invention also comprises a method of providing and operating an engine of enhanced fuel efficiency, as described in part above. One application of the method comprises a step of mixing an air and fuel mixture within a compression cylinder, whereby the air and fuel are both independently added to the cylinder and/or they are introduced in a partially mixed form into the cylinder. The method further comprises the step of compressing the mixture so as to force the mixture through a plurality of inlets into a manifold cavity, preferably positioned within the top of the compression cylinder piston, such as a cap of the piston; selectively directing the mixture into the combustion chamber about at the beginning of the combustion cycle, where the directing step may comprise directing the mixture into the combustion piston and preferably within a delivery cavity within the combustion piston cap. If desired, the method may further comprising directing the mixture from the manifold cavity to a storage cavity within the compression cylinder piston, preferably the wrist pin connecting the piston to the piston rod, although it may be positioned in another location and still permit effective delivery of the air/fuel mixture.

The directing step may further comprises the delivery being selective such that the conduit of travel is opened and closed depending upon the relative positions of the compression cylinder and the combustion cylinder relative to the support wall separating both. In that regard, the method preferably comprises providing a compression cylinder piston with a lateral outlet fluidly connected to the manifold cavity and positioned within the piston so that it aligns with an aperture in the support wall at certain positions within the arc of oscillation. The method further comprises providing a combustion cylinder piston with a lateral outlet fluidly connected to the delivery cavity and positioned within the piston so that it aligns with the same support wall aperture at certain positions within the arc of oscillation of the combustion cylinder, although not necessarily at the same time that the lateral outlet of the compression cylinder piston aligns with the wall aperture.

The method may further be enhanced by the step of providing a flow of purge air from a blower or other means into the delivery cavity prior to the step of delivering fresh air/fuel mixture into the delivery cavity from the compression chamber. The method may also comprise directing a flow of purge air into the combustion chamber just immediately with or contemporaneous with the delivery of fresh charge into the combustion chamber at the beginning of the next cycle.

H. Crankshaft Assembly

A detailed description of other features of the present invention may now be described. Referring back to FIG. 2, it can be seen that the crankshaft assembly 80 is positioned parallel to power trunnion tube 22 and is held in position by the three parallel crankcase support plates 14, 15 and 16. “Thus, these crankcase support plates not only support the air trunnions 31 and power trunnion tube 22, but also the crankshaft assembly 80. The crankshaft assembly 80 includes a plurality of separate members that are interconnected by mechanical fasteners, such as bolts 81 (shown in phantom). These separate members include the air crank throw 35 and the power crank throw 55 which are securely held together by the bolts 81. Constructing the crankshaft assembly 80 out of separate members allows it to be easily disassembled and readily serviced. This facilitates the removal of a worn rod journal pin giving a new interrace roller bearing.

Referring back to FIG. 1, the improved engine 10 preferably includes two power modules arranged in a side-by-side relationship. Each module transfers the generated power to the crankshaft 80 that is selectively connected to a central drive shaft 110 by a slidable output gear 112. The slidable output gear 112 is selectively connected to the crankshaft 80 by pins 114 and 116 that fit within openings in the end of each crankshaft 80. When the power from the selected power module is desired to be connected to the central drive shaft 110, the output gear 112 is moved such that the pins 114 and 116 engage the openings. Alternatively, when the pins 114 and 116 are disengaged from the crankshaft 80, the module is not connected to the central drive shaft 110. Thus, the output gear 112 located between the two modules can engage both of the crankshafts 80 of the side-by-side modules (as shown), or the output gear 112 may be moved such that it only engages a single module.

Referring now to FIG. 24, an alternative embodiment of a crankshaft may be described that facilitates breakdown of the crank for service and/or replacement. As shown, this alternative embodiment comprises a segmented crankshaft 600 comprising first and second portions 602, 604 each having a leg 606, 608 that are joined at an interface 610 and that are axially offset for the axis of rotation of the crankshaft 600. The interface 610 is positioned preferably aligned with the bearing for the piston rod serving the combustion chambers. If desired, addition segments may be provided such that an additional interface is positioned aligned with the pumper chamber.

Axially constraining the first and second portions is a pin 612 seated within an aligned bore 616a and 616b in each of the first and second legs 606, 608. Bore 616a descends only partially through the first leg 606 while bore 616b traverses the entire leg 608 of the second portion to permit access by a tool to a head portion 618 of the pin 612. Radially constraining the first and second portions of the crankshaft 600 is a plurality of keys 620 positioned radially within keyways about interface 610. Preferably four keys 620 are used at approximately 90° positions, although other quantities of keys, or the four keys being positioned at different radial positions, would effectively permit ready breakdown without sacrificing effective crankshaft operation when in place. Having a breakdown crankshaft as described herein would permit the user to remove the charge (or compression or pumper) cylinder, its piston and the portion of the crankshaft supporting the piston from the engine in unison.

I. Variable Compression Ratio System

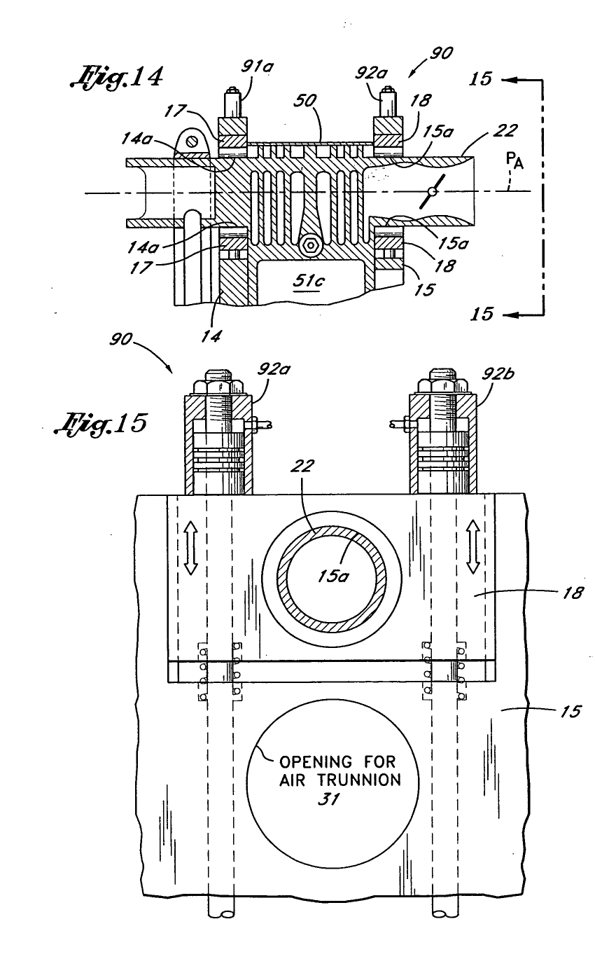

Referring now to FIGS. 14 and 15, the variable compression ratio system 90 can be described. The purpose of the variable compression ratio system is to control the amount of desired pressure developed in the combustion chamber 51c. The variable compression ratio system 90 allows varying degrees of compression to accommodate the use of different types of fuel and to accommodate fuels having different levels of octaves. Broadly, the pressure is controlled by adjusting the volume of the combustion chamber 51c in the power cylinder in which the fuel mixture is compressed. The volume is adjusted by varying the distance between the axis of rotation PA of the power trunnion tube 22 and power pistons 53a,b. As shown in FIG. 14, the power trunnion tube 22 extends through, and is supported by, bearings located within an opening 14a in crankcase support plate 14 and an opening 15a in crankcase support plate 15. The openings 14a and 15a are contained within linearly movable compression plates 17 and 18 of the crankcase support plates 14 and 15, respectively, which movable compression plates 17 and 18 move relative to the balance of crankcase support plates 14 and 15. Because the power cylinder 50 is integral with the power trunnion tube 22, an operator moving compression plates 17 and 18 necessarily moves the power trunnion tube 22 (and power cylinder 50) relative to the power pistons 53a,b and the crankshaft assembly 80 (not shown). This adjustment changes the size of the combustion chamber 51c.

Movement of compression plates 17 and 18 is controlled by a first set of hydraulic assemblies 91a and 92a (FIG. 14) and a second set of hydraulic assemblies 91b (not shown) and 92b (FIG. 15). As shown more clearly in FIG. 15, the hydraulic assemblies 92a and 92b preferably comprise pistons translated linearly within cylinders by the flow of hydraulic fluid on either side of the pistons. Movement of the hydraulic pistons results in linear movement of the power trunnion tube in a direction normal to its axis of rotation, as shown by the arrows. While FIG. 15 shows the hydraulic assemblies 92a,b for moving compression plate 18 of support plate 15, it should be understood that compression plate 17 of support plate 14 is similarly controlled by hydraulic assemblies 91a (FIG. 14) and 91b (not shown). However, it is contemplated that other mechanical systems may be employed for moving the power trunnion tube 22 relative to the power pistons 53a,b in order to vary the compression ratio.

With the present invention, it is contemplated that an electronic sensor will be positioned in the gas tank to detect the octane levels of the fuel. Controls linked to the sensor will then hydraulically move the compression plates accordingly. It is also contemplated that a bubble level can be used at some location within the vehicle to which the present invention is incorporated in order to detect whether the vehicle is moving up or down a grade. The compression ratio may be varied to respond to travel up or down a grade to increase compression as needed—i.e., either to increase power or to function as a brake, respectively.

An alternative embodiment of a variable compression feature is also contemplated. Referring to FIG. 25, the alternative variable compression feature can be described. In the preferred alternative embodiment, a trunnion 700 about which the combustion chamber (not shown) oscillates sits within an eccentric ring 702 that itself sits within an aperture 704 in the support wall 706 that supports the trunnion 700. The eccentric ring 702 is configured to rotate within the aperture 704 to a position set by adjustment lever 712 that the user can use to adjust the radial position of the ring 702 relative to the aperture 704. Given its eccentricity, the radial position of the ring 702 relative to the aperture 704 sets the distance from the centerline of the trunnion 700 to the bottom of the combustion chamber. Preferably, the eccentric ring 702 is configured so that the trunnion may be adjusted in height relative to the chamber about 62/1000 inches, although other dimensions may be manufactured and still provide effective compression variability. If desired, yet another alternative embodiment comprises positioning the eccentric ring within an axial slot (not shown) so that as the ring rotates, lateral movement does not occur of the trunnion does not occur. In other words, as the ring radial position is adjusted by the user, the slot restricts lateral movement of the trunnion and forces the trunnion into an axial movement relative to the bottom of the combustion chamber.

J. Electrical Ignition System

Referring now to FIGS. 16 and 17, the electrical ignition system 100 can be described in detail. The electrical ignition system 100 relies upon the oscillating motion of the power cylinder 50 to control the delivery of electrical charges to spark plugs 101a,b at the top of the power cylinder. As shown in FIG. 16, the spark plugs 101a,b protrude through the head of the power cylinder 450 so that they project into combustion chambers of barrels 451a, 451b. While FIG. 16 shows spark plugs delivering a spark to two separate combustion chambers, in accordance with the alternative embodiment described below, the spark plugs may be employed with a single shared combustion chamber, as described above and shown in FIG. 7. Depending upon the specific burn pattern or combustion characteristics desired, the number of spark plugs 100 may be varied. Additionally, the location of the spark plugs 101 in the combustion chambers 451a, 451b may also be varied as required.

Referring to FIG. 17, the timing of the electrical current provided to the spark plugs is controlled by oscillation of the power cylinder 450. Each spark plug 101 is serviced by a spark plug wire 102 having a lead at a distal end connected to an electrical contact 103 supported by a bracket 104. Both electrical contacts 103 surround a center electrode 1.05 that is connected to an electrical source such as a battery (not shown). Oscillation of the power cylinder 450 periodically aligns the center electrode 105 with both electrical contacts 103 to allow electrical current to flow from the center electrode 105, through the electrical contacts 103 and spark plug wires 102, to the spark plugs 101. Thus, like the delivery of fuel and air into the power cylinder 450, the firing of spark plugs 101 and ignition of the fuel-air mixture in the combustion chambers 451a,b are controlled by oscillation of the power cylinder 450.

It should be understood and appreciated that any desired number of power modules may be employed either in side-by-side relation, as shown in FIG. 1 (## 11 and 12), or at various angular intervals about a common axis in order to obtain the desired power output and capacity of the device. Moreover, one or more power modules and central drive shafts may be combined according to the desired power output of the engine.

The present invention may be embodied in other specific forms without departing from its spirit or essential characteristics. The described embodiments are to be considered in all respects only as illustrative, and not restrictive. The scope of the invention is, therefore, indicated by the appended claims, rather than the foregoing description. All changes which come within the meaning and range of equivalency of the claims are to be embraced within their scope.

1. (canceled)

2. An improved engine for enhancing fuel burn efficiency, said improved engine including first and second oscillating cylinders, the first cylinder being configured for compressing air and the second cylinder being configured for effectuating combustion of fuel and air during periodic combustion steps, the improvement comprising means for dispersing fuel within the mixture and/or for enhancing vaporization of such fuel prior to combustion, said dispersing and/or vaporization enhancing means comprising a first cavity positioned within a piston of the first or second cylinder, wherein the cavity is in a piston reciprocating within the first cylinder.

3. The engine of claim 2, wherein the dispersing and/or vaporization enhancing means further comprises a second cavity positioned within a piston reciprocating within the second cylinder, said first and second cavity being selectively in fluid communication with each other.

4. The engine of claim 3, wherein the dispersing and/or vaporization enhancing means further comprises a storage cavity between the first and second cavity for temporary storage of the air/fuel mixture prior to the select delivery of said mixture to the second cavity.

5. The engine of claim 2, wherein the first cavity comprises a plurality of inlets each with a check valve positioned therein, said check valves configured to be opened upon the exertion of a pressure exerted on the valves associated with the compression of the air/fuel mixture.

6. An improved engine for enhancing fuel burn efficiency, said improved engine including first and second oscillating cylinders, the first cylinder being configured for compressing air and the second cylinder being configured for effectuating combustion of fuel and air during periodic combustion steps, the improvement comprising means for dispersing fuel within the mixture and/or for enhancing vaporization of such fuel prior to combustion, said dispersing and/or vaporization enhancing means comprising a first cavity positioned within a piston of the first or second cylinder, the improvement further comprising means for directing forced air into the combustion chamber to exhaust combustion from the combustion chamber.

7. The engine of claim 6, wherein the dispersing and/or vaporization enhancing means is configured to permit forced air to purge the second cavity of any backflow in exhaust prior to the delivery of fresh air/fuel mixture.

8. An improved engine for enhancing fuel burn efficiency, said improved engine including first and second oscillating cylinders, the first cylinder being configured for compressing air and the second cylinder being configured for effectuating combustion of fuel and air during periodic combustion steps, the improvement comprising means for dispersing fuel within the mixture and/or for enhancing vaporization of such fuel prior to combustion, said dispersing and/or vaporization enhancing means comprising a first cavity positioned within a piston of the first or second cylinder, the improvement further comprising an adjustable trunnion supporting the combustion cylinder for varying.

9. An improved engine for enhancing fuel burn efficiency, said improved engine including first and second oscillating cylinders, the first cylinder being configured for compressing air and the second cylinder being configured for effectuating combustion of fuel and air during periodic combustion steps, the improvement comprising means for dispersing fuel within the mixture and/or for enhancing vaporization of such fuel prior to combustion, said dispersing and/or vaporization enhancing means comprising a first cavity positioned within a piston of the first or second cylinder, the improvement further comprising means for delivering cracked water to the combustion chamber such that hydrogen is injected into the combustion chamber to enhance combustion.

10. A method of improving fuel dispersion and/or vaporization within an engine comprising the steps of
compressing a mixture of fuel and air within a compression chamber;
forcing the mixture through a plurality of inlets into a manifold cavity;
temporarily storing said mixture to await discharge from the compression chamber; and
selectively delivering said mixture to a combustion chamber.

11. The method of claim 10, wherein the step of selective delivery comprises delivering the mixture to a delivery cavity within the combustion chamber prior to release to the combustion chamber, said delivery cavity being in periodic fluid communication with the manifold cavity at select points in the combustion cycle.

12. The method of claim 10, further comprising the step of delivering forced air into the combustion chamber approximately at the time of delivery of the air/fuel mixture into the combustion chamber.

13. The method of claim 12, further comprising selectively directing forced air into the delivery chamber to purge the delivery chamber of exhaust backflow prior to introduction of fresh charge of mixture.

14. The method of claim 10, wherein the manifold cavity is positioned within the piston of the compression chamber.

15. The method of claim 11, wherein the delivery cavity is positioned within the piston of the combustion chamber.
